(19) United States
(12) Patent Application Publication
(10) Pub. No.: US 2024/0399583 A1
(43) Pub. Date: Dec. 5, 2024

(54) OBSTACLE DETECTION METHOD AND APPARATUS, DEVICE, AND STORAGE MEDIUM

(71) Applicant: Guangdong Lyric Robot Automation Co., Ltd., Huizhou (CN)

(72) Inventors: De Chen, Huizhou (CN); Shaolei Zhong, Huizhou (CN); Hai Wang, Huizhou (CN); Dechao Wang, Huizhou (CN); Changpeng Ding, Huizhou (CN)

(21) Appl. No.: 18/697,027

(22) PCT Filed: Dec. 20, 2022
(86) PCT No.: PCT/CN2022/140355

§ 371 Date: Mar. 29, 2024

(30) Foreign Application Priority Data
May 9, 2022 (CN) 202210497687.9

(51) Int. Cl. B25J 9/16; B25J 5/00

(52) U.S. Cl. CPC B25J 9/1676; B25J 5/007

(57) ABSTRACT

Provided are an obstacle detection method and apparatus, a device and a storage medium. The obstacle detection method may include: determining a detection planar region according to a mobile robot and a target position, wherein a distance from a point in the detection planar region to a connecting line between the mobile robot and the target position does not exceed a detection fixed value; determining a shortest distance from an obstacle to the connecting line between the mobile robot and the target position based on a vector distance method; and determining whether the obstacle is present in the detection planar region according to a result of comparison of the shortest distance with the detection fixed value.

### CROSS REFERENCE TO RELATED APPLICATIONS

This application is a national stage filing under 35 U.S.C. § 371 of international application number No. PCT/CN2022/140355, filed Dec. 20, 2022, which claims priority to Chinese patent application No. 202210497687.9, filed May 9, 2022. The contents of these applications are incorporated herein by reference in their entirety for all purposes.

### TECHNICAL FIELD

The present disclosure relates to the technical field of intelligent logistics equipment, and specifically to an obstacle detection method and apparatus, a device, and a storage medium.

### BACKGROUND

An AGV (automated guided vehicle) is a transportation vehicle that is equipped with an automatic navigation apparatus, such as an electromagnetic or optical one, and is thus capable of traveling along a prescribed navigation path, with safety protection and various load transfer functions. Driver-less carriers for industrial applications are powered by rechargeable batteries. Generally, the path of travel and behavior thereof can be controlled by computers, or the path of travel thereof can be set up using electromagnetic tracks, which are adhered to the floor, and the unmanned carriers rely on the information brought by the electromagnetic tracks to move and act.

At present, in the chaotic environment of an AGV vehicle transporting cargos into an elevator, due to the inability to accurately identify and detect obstacles, the AGV vehicle can only stop and wait in place and wait for the obstacles to leave before the AGV vehicle gets into operation and movement, which seriously affects the efficiency of transportation and leads to poor safety and easy collisions.

### SUMMARY

In view of this, an objective of embodiments of the present disclosure is to provide an obstacle detection method and apparatus, a device and a storage medium, where by establishing a fixed value detection region between the mobile robot and the target point, the shortest distance from the obstacle to the connecting line between the mobile robot and the target point is solved by using the vector distance method, and according to the magnitude relationship between the fixed value and the shortest distance, it can be determined whether the obstacle is present in the detection region, thus realizing the accurate detection of the obstacle, thereby solving the technical problem of “the inability to accurately identify and detect obstacles affects the efficiency of transportation and leads to poor safety and easy collisions” mentioned above.

In accordance with a first aspect of the present disclosure, an embodiment provides an obstacle detection method, including: determining a detection planar region according to a mobile robot and a target position, where a distance from a point in the detection planar region to a connecting line between the mobile robot and the target position does not exceed a detection fixed value; determining a shortest distance from an obstacle to the connecting line between the mobile robot and the target position based on a vector distance method; and determining whether the obstacle is present in the detection planar region according to a result of comparison of the shortest distance with the detection fixed value.

In the above implementation process, by establishing points from which the distances to the connecting line between the mobile robot and the target point do not exceed the detection fixed value, a detection planar region of one rectangle plus two semicircles can be formed, and laser scanning detection is performed in the region and the minimum distance of an obstacle from the region is calculated and, when the obstacle is identified to enter the region, the mobile robot avoids it, thereby improving the work efficiency of transportation by the mobile robot. The shortest distance from a point to a line segment is calculated by means of a vector distance method, thus enabling the mobile robot to perform identification more accurately and thus be less prone to collisions, thereby improving the safety of transportation and the efficiency of identification of the mobile robot.

Optionally, the determining whether the obstacle is present in the detection planar region according to a result of comparison of the shortest distance with the detection fixed value includes: determining that the obstacle is present in the detection planar region if the shortest distance is less than the detection fixed value; and determining that the obstacle is not present in the detection planar region if the shortest distance is greater than the detection fixed value.

In the above implementation process, by directly determining the magnitude relationship between the shortest distance and the detection fixed value through comparison, it can be determined whether an obstacle is present in the detection region, and whether for a dynamic obstacle or a static obstacle, the detection can be quickly performed. This detection method is simple and easy to implement with low algorithmic complexity, thus improving the efficiency of detection and identification.

Optionally, the determining a shortest distance from an obstacle to the connecting line between the mobile robot and the target position based on a vector distance method includes: determining a positional relationship of the obstacle to the mobile robot and the target position according to a current position of the obstacle; and determining, according to the positional relationship, the shortest distance from the obstacle to the connecting line between the mobile robot and the target position by means of the vector distance method.

In the above implementation process, the shortest distance from the obstacle point to the connecting line between the target point and the robot point is solved by using a vector distance calculation method from a point to a line segment to ensure that there are no singular values so that the mobile robot can perform identification more accurately and is not prone to collisions, which simplifies the detection algorithm and allows for a high computation speed, thereby improving the safety of transportation and the efficiency of identification.

Optionally, the determining, according to the positional relationship, the shortest distance from the obstacle to the connecting line between the mobile robot and the target position by means of the vector distance method includes: determining, if the obstacle is located in an inner region between the mobile robot and the target position, the magnitude of a vertical line segment from the obstacle to the connecting line between the mobile robot and the target position as the shortest distance.

In the above implementation process, in this way, it is possible to quickly derive the shortest distance from the obstacle to the connecting line between the mobile robot and the target position in the case where the position of the obstacle point is located in a region between the robot and the target point among three cases, thus enabling the mobile robot to detect the obstacle very quickly, thereby improving the safety of transportation and the efficiency of identification.

Optionally, the determining, according to the positional relationship, the shortest distance from the obstacle to the connecting line between the mobile robot and the target position by means of the vector distance method includes: determining, if the obstacle is located in an outer region of the mobile robot far from the target position, the magnitude of a straight-line distance from the obstacle to the mobile robot as the shortest distance.

In the above implementation process, in this way, it is possible to quickly derive the shortest distance from the obstacle to the connecting line between the mobile robot and the target position in the case where the position of the obstacle point is located in an outer region of the robot far from the target point among three cases, thus enabling the mobile robot to detect the obstacle very quickly, thereby improving the safety of transportation and the efficiency of identification.

Optionally, the determining, according to the positional relationship, the shortest distance from the obstacle to the connecting line between the mobile robot and the target position by means of the vector distance method includes: determining, if the obstacle is located in an outer region of the target position far from the mobile robot, the magnitude of a straight-line distance from the obstacle to the target position as the shortest distance.

In the above implementation process, in this way, it is possible to quickly derive the shortest distance from the obstacle to the connecting line between the mobile robot and the target position in the case where the position of the obstacle point is located in an outer region of the target point far from the robot among three cases, thus enabling the mobile robot to detect the obstacle very quickly, thereby improving the safety of transportation and the efficiency of identification.

Optionally, the method further includes: acquiring a mobile robot height and an obstacle height; and determining whether the obstacle is present in the detection planar region in a vertical direction according to a result of comparison of the mobile robot height with the obstacle height.

In the above implementation process, by means of a range comparison in the vertical direction, the presence or absence of an obstacle in the vertical direction can be detected. By combining obstacle detections in the horizontal plane and in the vertical direction, it is possible to realize the detection of various obstacles, thereby improving the safety of transportation and the efficiency of identification.

In accordance with a second aspect of the present disclosure, an embodiment provides an obstacle detection apparatus, the apparatus including: a detection region determination module for determining a detection planar region according to a mobile robot and a target position, where a distance from a point in the detection planar region to a connecting line between the mobile robot and the target position does not exceed a detection fixed value; a shortest-distance calculation module for determining a shortest distance from an obstacle to the connecting line between the mobile robot and the target position based on a vector distance method; and an obstacle determination module for determining whether the obstacle is present in the detection planar region according to a result of comparison of the shortest distance with the detection fixed value.

In accordance with a third aspect of the present disclosure, an embodiment further provides an electronic device, including: a processor and a memory storing machine-readable instructions executable by the processor, wherein when the electronic device is in operation, the machine-readable instructions, when executed by the processor, perform the steps of the method described above.

In accordance with a fourth aspect of the present disclosure, an embodiment provides a non-transitory computer-readable storage medium storing a computer program which, when executed by a processor, causes the processor to perform the steps of the method described above.

To facilitate a better understanding of the objective, features, and advantages of the present disclosure, embodiments are set forth below and are described in detail with reference to the accompanying drawings.

### BRIEF DESCRIPTION OF DRAWINGS

In order to describe the technical schemes of embodiments of the present disclosure more clearly, the accompanying drawings required in the embodiments of the present disclosure will be described briefly below. It should be understood that the following accompanying drawings illustrate only some embodiments of the present disclosure and therefore should not be construed as a limitation on the scope thereof. For those of ordinary skill in the art, other relevant accompanying drawings can also be obtained from these accompanying drawings without any creative effort.

FIG. 1 is a flowchart of a first obstacle detection method provided by embodiments of the present disclosure;

FIG. 2 is a flowchart of a second obstacle detection method provided by embodiments of the present disclosure;

FIGS. 3(a), 3(b) and 3(c) are schematic diagrams of three positional relationships provided by embodiments of the present disclosure;

FIG. 4 is a schematic diagram of functional modules of an obstacle detection apparatus provided by embodiments of the present disclosure; and

FIG. 5 is a schematic block diagram of an electronic device of an obstacle detection apparatus provided by embodiments of the present disclosure.

Reference numerals: 210—Detection region determination module; 220—Shortest—distance calculation module; 230—Obstacle determination module; 300—Electronic device; 311—Memory; 312—Storage controller; 313—Processor; 314—Peripheral interface; 315—Input/output unit; 316—Display unit.

### DETAILED DESCRIPTION

The technical schemes in the embodiments of the present disclosure are clearly and completely described in the following with reference to the drawings in the embodiments of the present disclosure. It is obvious that the described embodiments are only some of the embodiments of the present disclosure and are not all the embodiments. Generally, the components of embodiments of the present disclosure described and illustrated in the drawings herein may be arranged and designed in a variety of different configurations. Therefore, the following detailed description of the embodiments of the present disclosure in the accompanying drawings is not intended to limit the scope of protection of the present disclosure, but merely represents selected embodiments of the present disclosure. All other embodiments obtained by a person of skill in the art based on the embodiments of the present disclosure without inventive effort are within the scope of the present disclosure.

It should be noted that similar symbols and letters denote similar items in the following accompanying drawings, so that once an item is defined in an accompanying drawing, no further definition or explanation of it is required in the subsequent accompanying drawings. The terms “comprise”, “include” or any variation thereof are intended to cover a non-exclusive inclusion, such that a process, method, article, or device that includes a series of elements not only includes those listed elements but also includes other elements not expressly listed or further includes elements inherent to such a process, method, article, or device. An element preceded by “comprises/includes a/an” does not, without more constraints, preclude the existence of additional identical elements in the process, method, article, or apparatus that comprises/includes the element. The terms such as “first” and “second” are for the purpose of distinguishing description only and should not be construed as indicating or implying relative importance.

In the prior art, after an elevator arrives, a mobile robot directly enters the elevator without detecting obstacles in the elevator in advance, which relies on its global obstacle avoidance for deceleration and stopping. This approach has certain problematic defects, such as: if a mobile robot enters an elevator while a large object is exiting the elevator, there may be a blockage of the elevator door that prevents both parties from entering or exiting the elevator. Currently, the control of the operation of a mobile robot inside a single floor is already very stable and reliable, but when it is necessary to control the mobile robot to take the elevator to work across floors, there are often many abnormal situations. In the chaotic environment of transporting cargos into an elevator, due to the inability to accurately identify and detect obstacles, the mobile robot can only stop and wait in place and wait for the obstacles to leave before the mobile robot gets into operation and movement, which seriously affects the efficiency of transportation and leads to poor safety and easy collisions.

In view of the study mentioned above, an embodiment of the present disclosure provides an obstacle detection method, the method including: determining a detection planar region according to a mobile robot and a target position, where a distance from a point in the detection planar region to a connecting line between the mobile robot and the target position does not exceed a detection fixed value; determining a shortest distance from an obstacle to the connecting line between the mobile robot and the target position based on a vector distance method; and determining whether the obstacle is present in the detection planar region according to a result of comparison of the shortest distance with the detection fixed value. With this method, the region obstacle detection problem is transformed into a shortest distance problem, which makes it possible to quickly and easily detect in advance the presence or absence of obstacles in an arbitrary fixed region from the mobile robot to the elevator, thus providing the mobile robot with guidance as to whether to avoid the obstacle or to continue on its way, thereby improving the efficiency of transportation and the safety.

It should be understood that the mobile robot application scenarios of the obstacle detection method provided in the present disclosure are not limited to AGV vehicles, but can, for example, also be applied to AMRs (automated mobile robots). The following in the present disclosure is presented taking an AGV vehicle as an example.

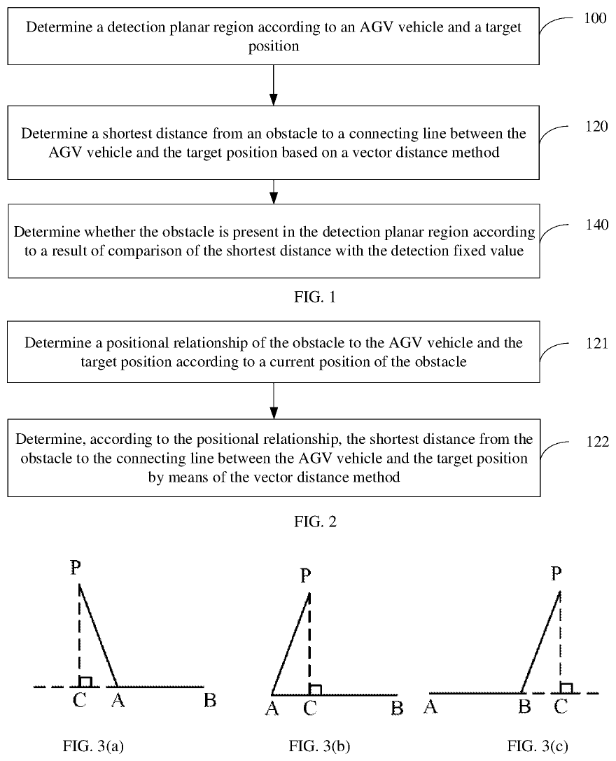

Referring to FIG. 1. FIG. 1 is a flowchart of a first obstacle detection method provided by embodiments of the present disclosure. The embodiment of FIG. 1 is described in detail below. The method may include: step 100, step 120, and step 140.

Among them, at step 100, a detection planar region is determined according to an AGV vehicle and a target position, where a distance from a point in the detection planar region to a connecting line between the AGV vehicle and the target position does not exceed a detection fixed value;
at step 120, a shortest distance from an obstacle to the connecting line between the AGV vehicle and the target position is determined based on a vector distance method; and
at step 140, it is determined whether the obstacle is present in the detection planar region according to a result of comparison of the shortest distance with the detection fixed value.

For step 100: a detection planar region is determined according to an AGV vehicle and a target position, where a distance from a point in the detection planar region to a connecting line between the AGV vehicle and the target position does not exceed a detection fixed value.

For example, the AGV vehicle may be a detection system mounted with multiple modules such as a laser scanning radar or 3D camera and a Bluetooth communication module and an upper computer, where the laser scanning radar acquires the coordinates of the position point of the vehicle, the coordinates of the obstacle point and the coordinates of the target point, and global positioning is performed based on laser navigation and laser scanning, and the Bluetooth communication module sends these parameters to the upper computer for processing and calculation, and the upper computer control ends controls the vehicle to avoid the obstacle and make a turn or to go forward and straight by means of control commands. The target position may be any position in the region near the AGV vehicle and may be the position where the elevator is located in a real-life elevator entry scenario. The detection fixed value may be a radius of action of the laser scanning radar mounted at the front of the AGV vehicle, which may be a fixed value that may be set arbitrarily. For example: the radius of action may be 6 m, and the laser scanning radar scans 360 degrees in all directions, which may be to scan the barricade situation in the surrounding 6 m continuously at a scanning frequency of 5.5 Hz, and ignore the influence of the terrain beyond the 6 m distance.

First, a determined detection fixed value is set for the AGV vehicle, and based on the principle of the shortest distance between two points, the shortest path from the AGV vehicle to the target position can be determined, i.e., the connecting line between the AGV vehicle and the target position, and then the detection planar region that can be detected by the AGV vehicle on this shortest path can be easily obtained, that is, a closed connected region formed by points in the planar region from which the distances to the connecting line between the AGV vehicle and the target position do not exceed the detection fixed value. It is not difficult to understand: the closed connected region is a connected region formed by a rectangular region with the connecting line between the AGV vehicle and the target position as the central axis, a circular region with the AGV vehicle as the center, and a circular region with the target position as the center, where the circular regions at the two ends overlap the rectangle to eventually form a detection planar region of one rectangle plus two semicircles. Meanwhile, since the detection fixed value can be set arbitrarily, the size of the detection planar region can be flexibly changed, which facilitates obstacle detection in a region of arbitrary range.

At step 120, a shortest distance from an obstacle to the connecting line between the AGV vehicle and the target position is determined based on a vector distance method;
at step 140, it is determined whether the obstacle is present in the detection planar region according to a result of comparison of the shortest distance with the detection fixed value.

For example, the shortest distance from the obstacle to the connecting line between the AGV vehicle and the target position can be abstracted as a mathematical problem of solving the distance from a point to a line segment, i.e., the distance from the obstacle point to a line segment formed by the connecting line between two points, i.e., the AGV vehicle and the target position, whereas the calculation of the distance from a point to a line segment can be performed utilizing a simple vector method. The idea of this vector distance method may be as follows: decomposing the distance from a point to a line segment into three cases where the projection of the point is on the line segment and the projection of the point is on the extension lines from the two ends of the line segment to further solve for the shortest distance from the obstacle point to the connecting line between the AGV vehicle and the target position.

The laser SLAM map coordinate system is used as a reference system to perform traversal for an obstacle and the shortest distance from the coordinates of the obstacle point to the connecting line between the target point and the AGV point is solved using a vector distance method from a point to a line segment, so as to ensure that there are no singular values. Further, a laser scanning radar or a 3D camera is used and the angular and distance polar coordinate system radar data of all the scanned obstacle points is transformed into xyz point Cartesian three-dimensional coordinate system cloud data relative to the AGV vehicle-based coordinate system, that is, a Cartesian three-dimensional xyz coordinate system takes the position point of the AGV vehicle as the origin, where the detection planar region is located in the xy coordinate system. By determining the magnitude relationship between the shortest distance solved above and the detection fixed value through comparison, it is possible to determine whether the obstacle is in the detection region, thus realizing the accurate detection of the obstacle.

Here, the way to acquire the coordinates of each position point can be as follows: first, by operations of the coordinates (x1, y1) and (x2, y2) of the vehicle twice before and after the movement, the direction of movement (x2-x1, y2-y1) of the AGV vehicle can be obtained. When an obstacle point is scanned, the distance between the obstacle point and the AGV vehicle can be obtained as s, and the angle between the connecting line between the obstacle point and the coordinates of the AGV vehicle and the body of the vehicle is 01, and according to the direction of movement, the angle between the body of the AGV vehicle and the X-axis can be deduced as θ2, whereas the coordinates of the AGV vehicle are known to be (x, y), then the coordinates of the obstacle point can be obtained as (x+s*cos(θ1+θ2), y+s*sin(θ1+θ2)). The coordinates of a dynamic obstacle point can be derived by solving for its instantaneous state coordinates, and the coordinates of the target position point and the coordinates of other obstacle points can be derived in a similar manner as described above. By means of laser scanning of a series of points, it is also possible to obtain a contour terrain around the AGV vehicle.

If the target position is an elevator, the AGV vehicle detects the presence or absence of obstacles such as people or objects in the target region according to the above method, and the detection logic for performing elevator entry may be: if there are people or objects in the elevator/or there is not enough space in the elevator to accommodate the AGV vehicle or the AGV vehicle and its cargo, the AGV vehicle sends out a voice notification, “I'm too fat to get in! I'll wait for the next time!”, and releases the elevator, calls the elevator again after a delay of 30 seconds, and waits for the next arrival of the elevator; if a person carries a large item and needs to go out of the elevator on this floor, there is enough space for the person to go out with the large item without affecting the normal use because the AGV vehicle is not executing elevator entry; if no obstacle is detected in the region, the AGV vehicle sends out a voice notification “The AGV vehicle is entering the elevator!” and executes the elevator entry command; and the AGV vehicle enters the elevator smoothly.

By establishing points from which the distances to the connecting line between the vehicle and the target point do not exceed the detection fixed value, a detection planar region of one rectangle plus two semicircles can be formed, and laser scanning detection is performed in the region and the minimum distance of the obstacle from the region is calculated and, when the obstacle is identified to enter the region, the AGV vehicle avoids the obstacle, thereby improving the work efficiency of transportation by the AGV vehicle. The shortest distance from a point to a line segment is calculated by means of the vector distance method, which enables the AGV vehicle to perform identification more accurately and thus be less prone to collisions, thereby improving the safety of transportation and the efficiency of identification of the AGV vehicle.

In an embodiment, step 140 may specifically include: step 141 and step 142.

At step 141, it is determined that the obstacle is present in the detection planar region if the shortest distance is less than the detection fixed value; and
at step 142, it is determined that the obstacle is not present in the detection planar region if the shortest distance is greater than the detection fixed value.

For example, the magnitude relationship between the shortest distance solved through the vector distance method above and the detection fixed value is determined through comparison, and if the shortest distance from the obstacle point to the connecting line between the AGV vehicle and the target position is less than the detection fixed value, since the detection planar region is formed according to the fact that the distances from the points in the planar region to the connecting line between the AGV vehicle and the target position are less than or equal to the detection fixed value, it indicates that the obstacle point is within the detection planar region, i.e., the AGV vehicle detects the obstacle within the detection planar region, and an obstacle avoidance operation can be performed and a re-planning of the vehicle path can be carried out, and for other obstacles, similar detections are performed; similarly, if the shortest distance from the obstacle point to the connecting line between the AGV vehicle and the target position is greater than the detection fixed value, it indicates that the obstacle point is outside the detection planar region, i.e., the AGV vehicle does not detect the obstacle within the detection planar region, and it can proceed straight ahead without obstacle avoidance.

By directly determining the magnitude relationship between the shortest distance and the detection fixed value through comparison, it can be determined whether an obstacle is present in the detection region, and whether for a dynamic obstacle or a static obstacle, the detection can be performed quickly. This detection method is simple and easy to implement with low algorithmic complexity, thus improving the efficiency of detection and identification.

Referring to FIG. 2. FIG. 2 is a flowchart of a second obstacle detection method provided by embodiments of the present disclosure. Step 120 in this method may specifically include: step 121 and step 122.

At step 121, a positional relationship of the obstacle to the AGV vehicle and the target position is determined according to a current position of the obstacle; and at step 122, according to the positional relationship, the shortest distance from the obstacle to the connecting line between the AGV vehicle and the target position is determined by means of the vector distance method.

For example, solving the shortest distance from the obstacle to the connecting line between the AGV vehicle and the target position by the vector distance method is abstracted as the mathematical problem of the distance from a point to a line segment. As shown in FIGS. 3(a), 3(b), and 3(c), schematic diagrams of three positional relationships provided by embodiments of the present disclosure are illustrated. Whether for a dynamic obstacle or a static obstacle, by acquiring the current position point (set as point P) of the obstacle and the line segment AB determined based on the position point (set as point A) of the AGV vehicle and the target position point (set as point B), three positional relationships formed from the point to the line segment can be obtained: the projection of P on AB is on AB, as shown in FIG. 3(b); the projection of P on AB is on the extension line of AB and is near the end A, as shown in FIG. 3(a); and the projection of P on AB is on the extension line of AB and is near the end B, as shown in FIG. 3(c);

Based on the vector distance method in mathematics, all of the above line segments are converted to vector forms for the purpose of solution, e.g., the line segment vector \vec{AB}, and the vectors formed by the point P and the two endpoints of the line segment: \vec{AP} and \vec{BP}. A dot product \vec{AP}·\vec{BP} of these two vectors is obtained, and the result of the dot product is the projection of \vec{AP} on \vec{AB}. In this case, the three positional relationships formed by the point to the line segment can be determined by simply comparing the projection to \vec{AB}. In the case where the projection is less than zero, which indicates that P is in the outer region at the end A, then the shortest distance is the magnitude of AP, i.e., |\vec{AP|}; in the case where the projection is greater than AB, which indicates that P is in the outer region at the end B, then the shortest distance is the magnitude of BP, i.e., |\vec{BP|}; and in the case where the projection is greater than zero and less than AB, which indicates that P is in the intermediate region of the line segment AB, then a vertical line is drawn across the point P to the line segment AB, with the foot of a perpendicular at C, then the shortest distance is the magnitude of the vertical line segment, that is, |\vec{CP|}.

The shortest distance from the obstacle point to the connecting line between the target point and the AGV point is solved by using a vector distance calculation method from a point to a line segment to ensure that there are no singular values so that the AGV vehicle can perform identification more accurately and is not prone to collisions, which simplifies the detection algorithm and allows for a high computation speed, thereby improving the safety of transportation by the AGV and the efficiency of identification.

In an embodiment, step 122 may specifically include: step 122a.

At step 122a, if the obstacle is located in an inner region between the AGV vehicle and the target position, the magnitude of a vertical line segment from the obstacle to the connecting line between the AGV vehicle and the target position is determined as the shortest distance.

For example, the inner region between the AGV vehicle and the target position refers to the case where “the projection is greater than zero and less than AB, which indicates that P is in the intermediate region of the line segment AB” in the above step 122, which is specifically as shown in FIG. 3(b), i.e., the case where “the projection of the point is on the line segment” in the above step 140, and it may specifically include: in the detection planar region, a whole connected region formed by a rectangular region with a connecting line between the position point of the AGV vehicle and the target position point as a central axis and the respective extension of the two connecting line length sides of the rectangle to the two sides. Further, according to the vector distance method in step 122, the shortest distance from the obstacle to the connecting line between the AGV vehicle and the target position may be calculated, i.e., the magnitude of the vertical line segment: |\vec{CP|}, the value of which is the length of CP.

In this way, it is possible to quickly derive the shortest distance from the obstacle to the connecting line between the AGV vehicle and the target position in the case where the position of the obstacle point is located in a region between the vehicle and the target point among three cases, thus enabling the AGV vehicle to detect the obstacle very quickly, thereby improving the safety of AGV transportation and the efficiency of identification.

In an embodiment, step 122 may specifically include: step 122b.

At step 122b, if the obstacle is located in an outer region of the AGV vehicle far from the target position, the magnitude of a straight-line distance from the obstacle to the AGV vehicle is determined as the shortest distance.

For example, the outer region of the AGV vehicle far from the target position refers to the case where “the projection is less than zero, which indicates that P is in the outer region at the end A” in the above step 122, which is specifically as shown in FIG. 3(a), i.e., one of the cases where “the projection of the point is on the extension lines from the two ends of the line segment” in the above step 140, and it may specifically include: in the detection planar region, a whole connected region formed by a semicircular region with the position point of the AGV vehicle as the center and the outward extension of the arcuate portion of the semicircle. Further, according to the vector distance method in step 122, the shortest distance from the obstacle to the connecting line between the AGV vehicle and the target position may be calculated, i.e., the magnitude of the line segment AP: |\vec{AP|}, the specific value of which can be derived from the angle formed by P and AB and the line segment distance AP according to the vector method.

In this way, it is possible to quickly derive the shortest distance from the obstacle to the connecting line between the AGV vehicle and the target position in the case where the position of the obstacle point is located in an outer region of the vehicle far from the target point among three cases, thus enabling the AGV vehicle to detect the obstacle very quickly, thereby improving the safety of AGV transportation and the efficiency of identification.

In an embodiment, step 122 may specifically include: step 122c.

At step 122c, if the obstacle is located in an outer region of the target position far from the AGV vehicle, the magnitude of a straight-line distance from the obstacle to the target position is determined as the shortest distance.

For example, the outer region of the AGV vehicle far from the target position refers to the case where “the projection is greater than AB, which indicates that P is in the outer region at the end B” in the above step 122, which is specifically as shown in FIG. 3(c), i.e., the other one of the cases where “the projection of the point is on the extension lines from the two ends of the line segment” in the above step 140, and it may specifically include: in the detection planar region, a whole connected region formed by a semicircular region with the target position point as the center and the outward extension of the arcuate portion of the semicircle. Further, according to the vector distance method in step 122, the shortest distance from the obstacle to the connecting line between the AGV vehicle and the target position may be calculated, i.e., the magnitude of the line segment BP: |\vec{BP|}, the specific value of which can be derived from the angle formed by P and AB and the line segment distance BP according to the vector method.

In this way, it is possible to quickly derive the shortest distance from the obstacle to the connecting line between the AGV vehicle and the target position in the case where the position of the obstacle point is located in an outer region of the target point far from the vehicle among three cases, thus enabling the AGV vehicle to detect the obstacle very quickly, thereby improving the safety of AGV transportation and the efficiency of identification.

In an embodiment, the method may further specifically include: step 150 and step 160.

At step 150, an AGV vehicle height and an obstacle height are acquired; and at step 160, it is determined whether the obstacle is present in the detection planar region in a vertical direction according to a result of comparison of the AGV vehicle height with the obstacle height.

For example, a Cartesian three-dimensional xyz coordinate system takes the position point of the AGV vehicle as the origin, where the detection planar region is located in the xy coordinate system. First, by means of the above steps 100, 120 and 140, it can be determined whether the obstacle is within the xy-dimensional detection planar region, thereby realizing obstacle detection in the xy-dimensional plane. Then, by acquiring the height of the obstacle, the three-dimensional coordinates of the obstacle point can be determined, where the Z-axis coordinate is the obstacle height value, which is set to h, the height value being negative if it is below the detection planar region; and the Z-axis coordinate of the position point of the AGV vehicle is the AGV vehicle height value, which is set to H, and a fixed range (0, H) is established according to the AGV vehicle height value and the origin.

Further, a judgment detection is carried out through comparison of whether h is within the fixed range (0, H), where in the case of a positive height value, if h is within the fixed range (0, H), i.e., if the obstacle height value h is less than the AGV vehicle height value H, it is determined that an obstacle is present in the detection planar region in the vertical direction; and if the obstacle point is below the detection planar region, the height value h is negative and h is not in the fixed range (0, H), or the height value h is positive and since the obstacle height value h is greater than the AGV vehicle height value H, h is not in the fixed range (0, H), then it is determined that no obstacle is present in the detection planar region in the vertical direction. By means of a range comparison in the vertical direction, the presence or absence of an obstacle in the vertical direction can be detected. By combining obstacle detections in the horizontal plane and in the vertical direction, it is possible to realize the detection of various obstacles, thereby improving the safety of transportation and the efficiency of identification.

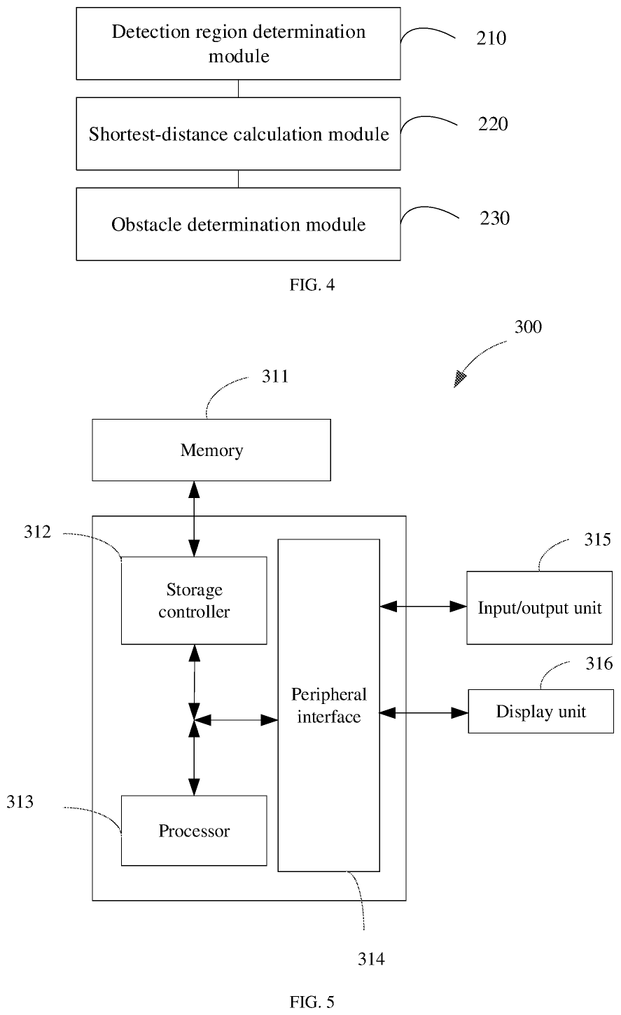

Referring to FIG. 4. FIG. 4 is a schematic diagram of functional modules of an obstacle detection apparatus provided by embodiments of the present disclosure. The apparatus may include: a detection region determination module 210, a shortest-distance calculation module 220, and an obstacle determination module 230.

Among them, the detection region determination module 210 is used for determining a detection planar region according to an AGV vehicle and a target position, where a distance from a point in the detection planar region to a connecting line between the AGV vehicle and the target position does not exceed a detection fixed value;
the shortest-distance calculation module 220 is used for determining a shortest distance from an obstacle to the connecting line between the AGV vehicle and the target position based on a vector distance method; and
the obstacle determination module 230 is used for determining whether the obstacle is present in the detection planar region according to a result of comparison of the shortest distance with the detection fixed value.

Optionally, the shortest-distance calculation module 230 may be used for:
determining that the obstacle is present in the detection planar region if the shortest distance is less than the detection fixed value; and
determining that the obstacle is not present in the detection planar region if the shortest distance is greater than the detection fixed value.

Optionally, the shortest-distance calculation module 220 may be used for:
determining a positional relationship of the obstacle to the AGV vehicle and the target position according to a current position of the obstacle; and
determining, according to the positional relationship, the shortest distance from the obstacle to the connecting line between the AGV vehicle and the target position by means of the vector distance method.

Optionally, the shortest-distance calculation module 220 may be used for:
determining, if the obstacle is located in an inner region between the AGV vehicle and the target position, the magnitude of a vertical line segment from the obstacle to the connecting line between the AGV vehicle and the target position as the shortest distance.

Optionally, the shortest-distance calculation module 220 may be used for:
determining, if the obstacle is located in an outer region of the AGV vehicle far from the target position, the magnitude of a straight-line distance from the obstacle to the AGV vehicle as the shortest distance.

Optionally, the shortest-distance calculation module 220 may be used for:
determining, if the obstacle is located in an outer region of the target position far from the AGV vehicle, the magnitude of a straight-line distance from the obstacle to the target position as the shortest distance.

Optionally, the obstacle detection apparatus may also be used for:
acquiring an AGV vehicle height and an obstacle height; and determining whether the obstacle is present in the detection planar region in a vertical direction according to a result of comparison of the AGV vehicle height with the obstacle height.

Referring to FIG. 5. FIG. 5 is a schematic block diagram of an electronic device. The electronic device 300 may include a memory 311, a storage controller 312, a processor 313, a peripheral interface 314, an input/output unit 315, and a display unit 316. Those of ordinary skill in the art can understand that the structure shown in FIG. 5 is only for illustrative purpose and does not impose a limitation on the structure of the electronic device 300. For example, the electronic device 300 may alternatively include more or fewer components than the components shown in FIG. 5 or have a different configuration than that shown in FIG. 5.

The memory 311, the storage controller 312, the processor 313, the peripheral interface 314, the input/output unit 315 and the display unit 316 mentioned above are electrically connected to each other, directly or indirectly, to realize the transmission or interaction of data. For example, these components may be electrically connected to each other by at least one communication bus or signal line. The processor 313 mentioned above is used for executing executable modules stored in the memory.

Among them, the memory 311 may be, but is not limited to, a random-access memory (RAM), a read-only memory (ROM), a programmable read-only memory (PROM), an erasable programmable read-only memory (EPROM), an electric erasable programmable read-only memory (EEPROM), etc. Among them, the memory 311 is used to store a program, and the processor 313 executes the program upon receiving an execution instruction, and the method executed by the electronic device 300 that is defined in the process disclosed in any one of the embodiments of the present disclosure may be applied in the processor 313 or implemented by the processor 313.

The processor 313 mentioned above may be an integrated circuit chip with signal processing capability. The processor 313 mentioned above may be a general-purpose processor, including a central processing unit (CPU), a network processor (NP), and the like; and it may also be a digital signal processor (DSP), an application specific integrated circuit (ASIC), a field-programmable gate array (FPGA), or other programmable logic device, a discrete gate or a transistor logic device, or a discrete hardware component. The disclosed methods, steps and logic block diagrams in the embodiments of the present disclosure can be implemented or executed. The general-purpose processor may be a microprocessor or the processor may be any conventional processor.

The peripheral interface 314 mentioned above couples various input/output apparatuses to the processor 313 and the memory 311. In some embodiments, the peripheral interface 314, the processor 313, and the storage controller 312 may be implemented in a single chip. In some other examples, they may be separately implemented by separate chips.

The input/output unit 315 mentioned above is used to provide input data to the user. The input/output unit 315 may be, but is not limited to, a mouse and a keyboard, or the like.

The display unit 316 mentioned above provides an interactive interface (e.g., a user operation interface) between the electronic device 300 and the user for the user's reference. In this embodiment, the display unit 316 may be a liquid crystal display or a touch display. The liquid crystal display or the touch display can display the process of execution of the program by the processor.

The electronic device 300 in this embodiment may be used to perform various steps in the various methods provided in embodiments of the present disclosure.

In addition, a further embodiment of the present disclosure provides a non-transitory computer-readable storage medium storing a computer program which, when executed by a processor, causes the processor to perform the steps of the method embodiments described above.

The computer program product for the above method provided in embodiments of the present disclosure includes a computer-readable storage medium storing program code, where instructions included in the program code can be used to perform the steps in the above method embodiments, as can be seen in the above method embodiments, which will not be repeated herein.

In the embodiments provided by the present disclosure, it should be understood that the disclosed apparatus(es) and method(s) can be realized in alternative ways. The apparatus embodiments described above are only for illustration. For example, the division of the modules and units is only a logic function division. In actual implementation, there may be alternative manners for the division, and as another example, multiple units or components may be combined or integrated into another system, or some features may be omitted or not implemented. Further, the mutual coupling or direct coupling or communication connection shown or discussed may be indirect coupling or communication connection through some communication interfaces, apparatuses or units, and may be in electrical, mechanical or other forms. The functional modules in the embodiments of the present disclosure may be integrated to form an independent unit or may exist as separate modules, or two or more of the modules may be integrated to form an independent unit.

It is to be noted that if the functions are implemented in the form of functional modules of software and sold or used as independent products, they can be stored in a computer-readable storage medium. On the basis of such understanding, the substance or the parts that contribute to the existing technology or a part of the technical schemes of the present disclosure may be embodied in the form of a software product, which is stored in a storage medium and includes a number of instructions to cause a computer device (which can be a personal computer, a server, or a network device, etc.) to execute all or some of the steps of the method described in the embodiments of the present disclosure. The aforementioned storage medium includes: various media that can store program codes, such as a USB flash drive, a mobile hard disk, a read-only memory (ROM), a random-access memory (RAM), a magnetic disk or an optical disk.

The relative terms herein, such as “first” and “second”, are used only to distinguish one entity or operation from another entity or operation, without necessarily requiring or implying any such actual relationship or sequence between these entities or operations.

The above is only the description of some embodiments of the present disclosure, and is not intended to limit the scope of protection of the present disclosure. It will be apparent to those of ordinary skill in the art that various modifications and variations can be made to the present disclosure. Any modifications, equivalent substitutions, improvements, etc. made within the spirit and principle of the present disclosure shall fall within the scope of protection of the present disclosure.

1. An obstacle detection method, comprising:
determining a detection planar region according to a mobile robot and a target position, wherein a distance from a point in the detection planar region to a connecting line between the mobile robot and the target position does not exceed a detection fixed value;
determining a shortest distance from an obstacle to the connecting line between the mobile robot and the target position based on a vector distance method; and
determining whether the obstacle is present in the detection planar region according to a result of comparison of the shortest distance with the detection fixed value.

2. The method of claim 1, wherein determining whether the obstacle is present in the detection planar region according to a result of comparison of the shortest distance with the detection fixed value comprises:
determining that the obstacle is present in the detection planar region if the shortest distance is less than the detection fixed value; and
determining that the obstacle is not present in the detection planar region if the shortest distance is greater than the detection fixed value.

3. The method of claim 1, wherein determining a shortest distance from an obstacle to the connecting line between the mobile robot and the target position based on a vector distance method comprises:
determining a positional relationship of the obstacle to the mobile robot and the target position according to a current position of the obstacle; and
determining, according to the positional relationship, the shortest distance from the obstacle to the connecting line between the mobile robot and the target position by means of the vector distance method.

4. The method of claim 3, wherein determining, according to the positional relationship, the shortest distance from the obstacle to the connecting line between the mobile robot and the target position by means of the vector distance method comprises:
determining, if the obstacle is located in an inner region between the mobile robot and the target position, the magnitude of a vertical line segment from the obstacle to the connecting line between the mobile robot and the target position as the shortest distance.

5. The method of claim 3, wherein determining, according to the positional relationship, the shortest distance from the obstacle to the connecting line between the mobile robot and the target position by means of the vector distance method comprises:
determining, if the obstacle is located in an outer region of the mobile robot far from the target position, the magnitude of a straight-line distance from the obstacle to the mobile robot as the shortest distance.

6. The method of claim 3, wherein determining, according to the positional relationship, the shortest distance from the obstacle to the connecting line between the mobile robot and the target position by means of the vector distance method comprises:
determining, if the obstacle is located in an outer region of the target position far from the mobile robot, the magnitude of a straight-line distance from the obstacle to the target position as the shortest distance.

7. The method of claim 1, further comprising: acquiring a mobile robot height and an obstacle height; and determining whether the obstacle is present in the detection planar region in a vertical direction according to a result of comparison of the mobile robot height with the obstacle height.

8. An obstacle detection apparatus, comprising:
a detection region determination module, configured for determining a detection planar region according to a mobile robot and a target position, wherein a distance from a point in the detection planar region to a connecting line between the mobile robot and the target position does not exceed a detection fixed value;
a shortest-distance calculation module, configured for determining a shortest distance from an obstacle to the connecting line between the mobile robot and the target position based on a vector distance method; and
an obstacle determination module, configured for determining whether the obstacle is present in the detection planar region according to a result of comparison of the shortest distance with the detection fixed value.

9. An electronic device, comprising a processor and a memory storing machine-readable instructions executable by the processor, wherein when the electronic device is in operation, the machine-readable instructions, when executed by the processor, perform the steps of the method of claim 1.

10. A non-transitory computer-readable storage medium, storing a computer program which, when executed by a processor, causes the processor to perform the steps of the method of claim 1.
